(19) United States
(12) Patent Application Publication
(10) Pub. No.: US 2017/0330155 A1
(43) Pub. Date: Nov. 16, 2017

(54) SYSTEM AND METHOD OF SCHEDULING PREPARATION AND CREATING TIMELINE FOR A USER TO ACHIEVE ANY SPECIFIC GOAL

(71) Applicant: Rahul Rana, Chino, CA (US)

(72) Inventor: Rahul Rana, Chino, CA (US)

(21) Appl. No.: 15/151,335

(22) Filed: May 10, 2016

(51) Int. Cl. G06Q 10/10; G06F 17/30

(52) U.S. Cl. CPC G06Q 10/1093; G06F 17/30342

(57) ABSTRACT

Methods, systems, and media are provided by which preparation can be scheduled and timeline of milestones can be created to achieve any specific goal for a user. Goals can be wide ranging, for example—taking a test (such as SAT, GMAT, GRE, etc.), learning a new skill (such as a new language, skiing, etc.), acquiring a degree, diploma, or certification, changing a job or career, choosing a career, travel, surgery, fitness related goals (such as weight loss, etc.), goals and targets at work, corporation goals, etc. User can be an individual, a group of individuals, a business or civic entity, a volunteer group, etc.

### CROSS-REFERENCE TO RELATED APPLICATIONS

This application claims the benefit of provisional patent application Ser. No. 62/161,541, filed on May 14, 2015 by the present inventor.

### BACKGROUND

### Prior Art

The following is a tabulation of some prior art that presently appears relevant:

U.S. Patents

| Pat. No. | Kind Code | Issue Date | Patentee |
|---|---|---|---|
| 6,047,260 | A | Apr. 4, 2000 | Levinson |
| 6,442,527 | B1 | Aug. 27, 2002 | Worthington |
| 6,445,968 | B1 | Sep. 3, 2002 | Jalla |
| 6,917,928 | B1 | Jul. 12, 2005 | Pellinat |
| 7,027,996 | B2 | Apr. 11, 2006 | Levinson |
| 2010/0217418 | A1 | Aug. 26, 2010 | Fontanot |
| 7,921,026 | B2 | Apr. 5, 2011 | O'Cull et al. |
| 8,360,785 | B2 | Jan. 29, 2013 | Park et al. |
| 8,672,686 | B2 | Mar. 18, 2014 | Ferreira |

### SUMMARY

In accordance with one embodiment a method to create a schedule for goals, comprising: a system, using at least one processing device or another machine, interacting with one or more experts to obtain expert-advice and develop schedule.

### DRAWINGS

FIG. 1 shows a schematic representation of the system and method, and modules' interaction.

FIG. 2 shows that portion marked as “A” will be distinct for different goals irrespective of user. i.e., for a given goal, “A” would be identical for any user. The remainder portion marked as “B” is specific to each distinct user. i.e., “B” changes with user even for the same goal.

FIG. 3 shows details of module GUIDE 10. The expert(s) might be replaced from time to time but some continuity shall be maintained, i.e., not all experts shall be replaced at a single point in time.

FIG. 4 shows details of module ALUMNUS 14.

FIG. 5 illustrates calculations required to determine the terms User Standing and User Achievement.

FIG. 6 shows a visual representation of timeline of milestones (or subgoals) with goal being the last milestone.

FIG. 7 shows timeline of milestones at t=0 in pictorial format (first embodiment).

FIGS. 8 and 9 show progress status of user (first embodiment, scenario 1).

FIG. 10 shows upcoming subgoals of user (first embodiment, scenario 1).

FIGS. 11 and 12 show progress status of user (first embodiment, scenario 2).

FIG. 13 shows upcoming subgoals of user (first embodiment, scenario 2).

FIG. 14 shows timeline of milestones at t=0 in pictorial format (second embodiment).

FIGS. 15 and 16 show progress status of user (second embodiment, scenario 1).

FIG. 17 shows upcoming subgoals of user (second embodiment, scenario 1).

FIGS. 18 and 19 show progress status of user (second embodiment, scenario 2).

FIG. 20 shows upcoming subgoals of user (second embodiment, scenario 2).

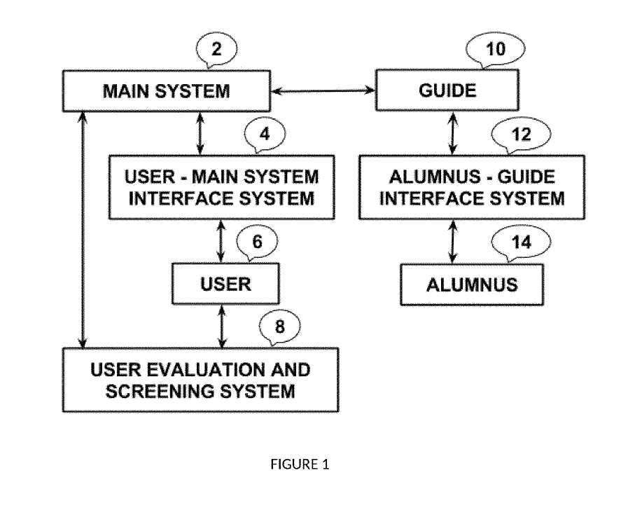

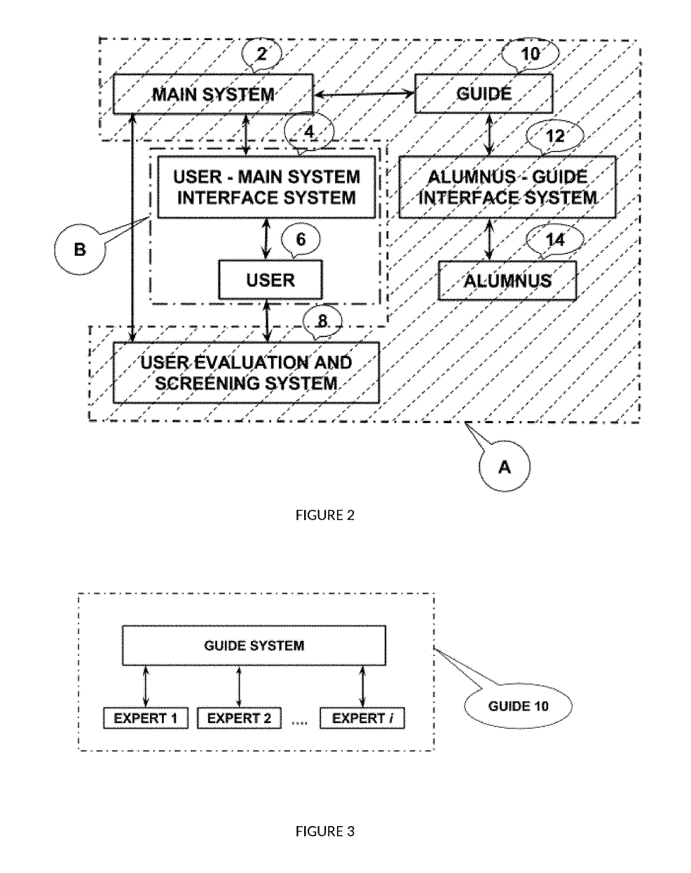

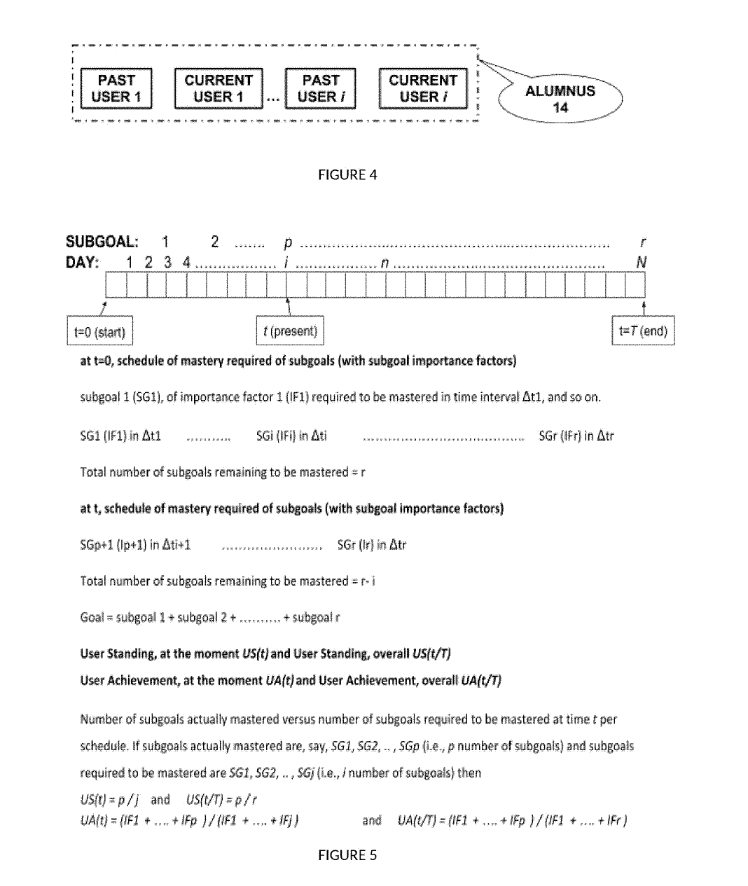

### DRAWINGS

### Reference Numerals

2 Main system

4 User-main system interface system

6 User

8 User evaluation and screening system

10 Guide

12 Alumnus-guide interface system

14 Alumnus

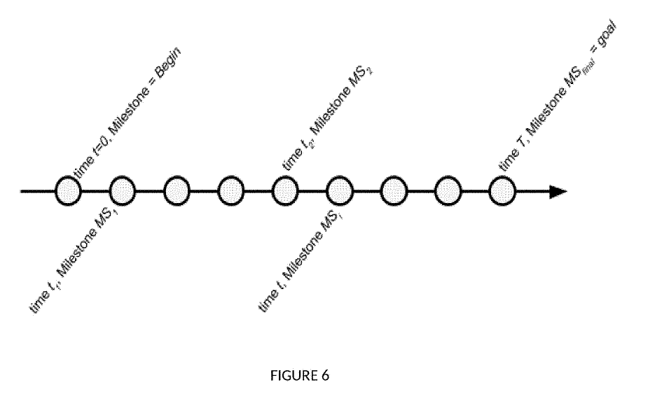

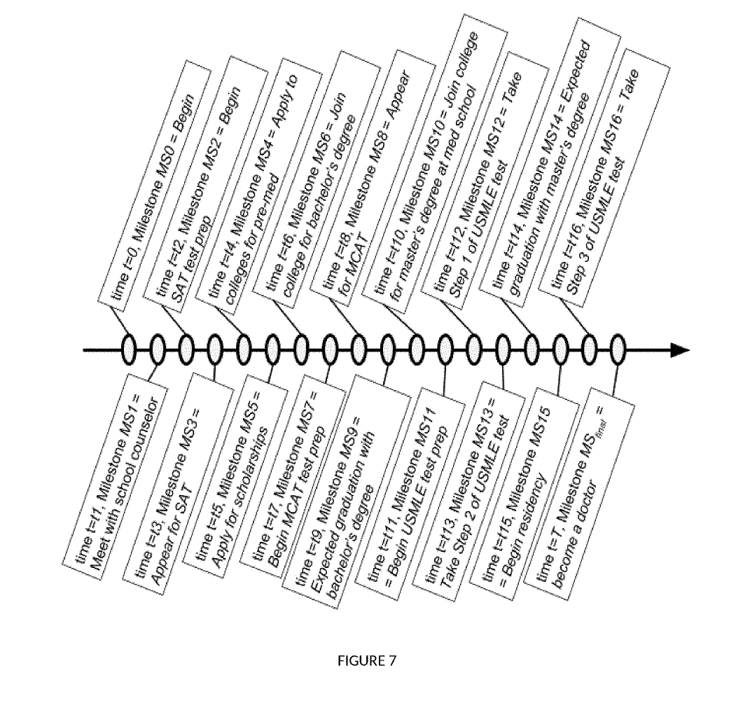

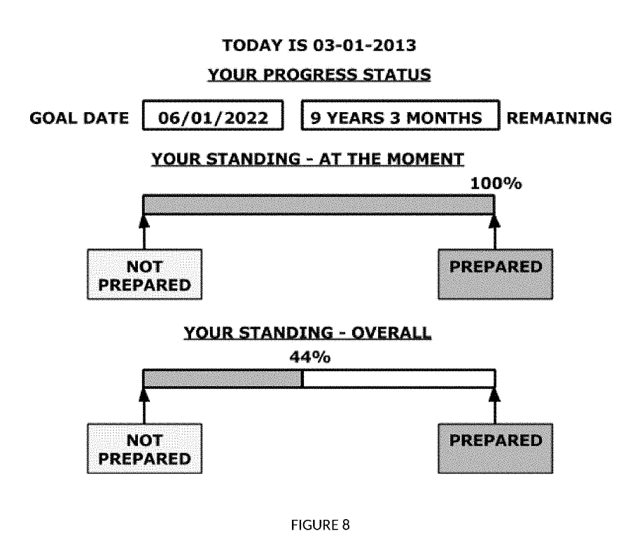

DEFINITIONS AND NOTATIONS

| Term | Definition (and Notation, if used) |
|---|---|
| Alumnus | One or more experienced user with or without current active |
| | subscription interested in and capable of sharing personal |
| | experience and provide feedback |
| Alumnus - Guides | A system consisting of one or more editable and addable rules and |
| Interface System | set of questions possibly implemented via software to manage |
| | Alumnus and Guides interaction |
| Conditional | A timeline of milestones to help user achieve goal at a specific time |
| Timeline | if a past milestone was not reached at time |
| Expert | A knowledgeable and experienced person, interested in and capable |
| | of sharing knowledge and expertise on specific topics |
| Goal | A desired achievement status to be reached in future |
| Guide | One or more Experts working with a system (Guide System) possibly |
| | implemented via software. See FIG. 3 |
| Guide System | A system, possibly implemented via software, consisting of one or |
| | more editable and addable rules and set of questions to manage |
| | experts, ask them questions, and record their feedback. Guide |
| | system collects and stimulates knowledge of experts by asking them |
| | questions. Guide system may be modified by experts. |
| Importance Factor | A number greater than or equal to one assigned to each subgoal to |
| | indicate relative importance of that subgoal towards goal |
| | achievement. Importance Factor of a subgoal can change with time |
| | and user's progress (Importance Factor of ith subgoal, IFi) |
| Main System | A system, possibly implemented via software (software may be |
| | adaptive), consisting of one or more editable and addable rules and |
| | set of questions dependent of user profile to interact with user to |
| | inform the user of their goal during a given period of time (e.g., a |
| | day, week, or month, etc.), and to inform the user where they stand |
| | vis-a-vis the goal. Main system communicates with user via user - |
| | main system interface system. Main system interacts with user |
| | evaluation and screening system to collect user profile. Main system |
| | interacts with guide to collect timeline of milestones, rules, and set |
| | of questions for a user profile |
| Milestone | A stage prior to or at achievement of goal when some or all of the |
| | subgoals have been mastered. See FIG. 6 (ith milestone MSi) |
| Subgoal | A part of Goal (ith subgoal SGi) |
| Timeline (or Original | A timeline of milestones determined at the start of working on goal |
| Timeline) | scheduled to help user achieve goal at a specific time. See FIG. 6. |
| User | An entity, e.g., a person, a group of people, a corporation, etc., |
| | having a goal and interested in enrolling into an embodiment of this |
| | invention |
| User Achievement | An indicator of subgoals mastered during a specific time interval |
| | versus subgoals required to be mastered during a specific time |
| | interval considering Importance Factors of subgoals (User |
| | Achievement, UA). For example: |
| | subgoals actually mastered vis-a-vis subgoals required to be |
| | mastered for time interval 0 to present (time t), User Achievement, |
| | at the moment UA(t); |
| | subgoals actually mastered vis-a-vis subgoals required to be |
| | mastered for arbitrary time interval Δti, User Achievement, arbitrary |
| | time interval UA(Δti); |
| | subgoals actually mastered till present (time t) vis-a-vis subgoals |
| | required to be mastered at the end (time T), User Achievement, |
| | overall UA(t/T) |
| | See FIG. 5 |
| User Evaluation and | A system, possibly implemented via software (software may be |
| Screening System | adaptive), consisting of one or more editable and addable rules and |
| | set of questions to evaluate and to screen a user. User evaluation |
| | and screening system runs at the beginning of user enrollment and |
| | periodically thereafter following various triggers and it seeks to |
| | generate a user profile. |
| User - Main System | A system, possibly implemented via software, consisting of one or |
| Interface System | more editable and addable rules and set of questions to manage |
| | user and main system interaction |
| User Profile | A type of user based on user's learning style, and specific range of |
| | skills and achievement at a given point in time. User Profile can |
| | change with time and, it indicates, at a given time, subgoals |
| | expected to be mastered in the remaining time. User Profile is used |
| | to determine approach for interaction between user and main |
| | system. |
| User Standing | An indicator of subgoals mastered during a specific time interval |
| | versus subgoals required to be mastered during a specific time |
| | interval (User Standing, US). For example: |
| | subgoals actually mastered vis-a-vis subgoals required to be |
| | mastered for time interval 0 to present (time t), User Standing, at |
| | the moment US(t); |
| | subgoals actually mastered vis-a-vis subgoals required to be |
| | mastered for arbitrary time interval Δti, User Standing, arbitrary |
| | time interval US(Δti); |
| | subgoals actually mastered till present (time t) vis-a-vis subgoals |
| | required to be mastered at the end (time T), User Standing, overall |
| | US(t/T) |
| | See FIG. 5 |

Note
User Standing (US) and User Achievement (UA) are somewhat related (but distinct) concepts. US is used to measure progress on subgoals assigned, UA is used to measure progress considering importance factor of subgoals.

### DETAILED DESCRIPTION

### First Embodiment

Goal—Career goal: Becoming Doctor

Setting Up of Modules

GUIDE 10

GUIDE 10 module consists of experts as following:
1. Two experts with SAT tutoring experience
2. Two experts with MCAT tutoring experience
3. Two experts with USMLE tests tutoring experience
4. Two experts with career counselling experience
5. Two experts who are physicians licensed within the last one year
6. Two experts who are students enrolled in undergraduate pre-medical program
7. One expert who is a student in medical school
8. One expert who is a student in medical residency
9. One expert—a student who has recently taken SAT
10. One expert—a student who has recently taken MCAT
11. Two experts who are parents or family members of students in medical school
12. One lead expert to facilitate reaching to conclusions based on inputs from all experts.

Note that actual number and type of experts can vary so long as adequate number of people who have knowledge and/or actual experience with at least a part of the process of becoming a doctor and who are interested in and capable of sharing their knowledge and expertise.

GUIDE 10 module also consists of Guide System (possibly implemented via software) which collects and stimulates knowledge of experts by asking these questions:

Questions Whose Answer are Used to Help Set Up MAIN SYSTEM 2
1. What is the typical path to becoming a doctor?
2. What steps or subgoals or milestones typically exist on this path?
3. How much time typically accomplishing or mastering each step takes?
4. While all steps would be important for final goal achievement, some would be more important than the others. Can you assign relative importance factors to various steps?
5. What is the best sequence for the steps considering their interdependencies?
6. What AP courses should be typically taken by a medical school aspirant?
7. What specializations are currently available to a medical student and how much time each specialization takes?
8. For each specialization option, are there any preferred AP courses?
9. What are premedical and medical college rankings and what GPA, SAT score, MCAT score, type of extra-curricular activity, and other items are recommended to increase possibility of acceptance to specific colleges?
10. Which standardized tests are required to be taken during the course of becoming a doctor and how much time is required to prepare for each of them?
11. On the path to becoming a doctor, for each specific step, if that specific step is not reached in time, what actions should be taken?
12. If you're in process of becoming a doctor, or, are a doctor, based on your personal experience, what advice can you offer to someone who is starting out or is behind you in the process?
13. If you're a family member of someone who is a doctor, or, is in the process of becoming a doctor, what advice can you offer to someone who'is in the process

Questions Whose Answer are Used to Help Set Up USER EVALUATION AND SCREENING SYSTEM 8
14. What typical medical aspirants profiles have you seen, and what are their characteristics? What questions would you ask to determine profile? How would a profile affect expected time to master a step, and is there a preferred order of steps for a given profile?

Questions Whose Answer are Used to Help Set Up ALUMNUS GUIDE INTERFACE SYSTEM 12
15. What questions would you ask alumni of this system to gather their experience in order to update and improve this system for a medical aspirant?

Experts can propose modifications in Guide System. Experts and lead expert collectively review their answers and create several default timelines of milestones at t=0 for different student profiles and several conditional timelines for various scenarios when original timeline was not adhered to. These timelines are saved as part of database in main system.

USER—MAIN SYSTEM INTERFACE SYSTEM 4

This module connects USER 6 to MAIN SYSTEM 2. It collects information from MAIN SYSTEM 2 and presents to USER 6, as well as collects input from USER 6 and uploads to MAIN SYSTEM 2. This module stores limited amount of information from MAIN SYSTEM 2 and USER 6 at any given time. As a computer analogy, this module serves as Random Access Memory (RAM) between Central Processing Unit (CPU) memory (analogous to MAIN SYSTEM 2) and input (analogous to USER 6).

### SPECIFIC EXAMPLE

A student towards end of 10th grade (i.e., towards end of high school sophomore year) chooses the goal of becoming a doctor. The student opens the web site (or calls phone number) of this system. The student interacts with USER EVALUATION AND SCREENING SYSTEM 8 module which asks certain questions and gathers information. Next, USER EVALUATION AND SCREENING SYSTEM 8 interacts with MAIN SYSTEM 2 and, using collected information, determines profile of the user and expected timeline of milestones for that profile. Next, USER EVALUATION AND SCREENING SYSTEM 8 provides the student a time range when the student is expected to become a doctor. If student is not satisfied with this time range (or any reason), student has choice to not enroll (and independently pursue achieving the goal in student's desired timeframe). If the student enrolls, the system creates an account and timeline at t=0 when student enrolled. Thus, if student enrolled on, say, May 15, 2008, then t=0 represents May 15, 2008.

Timeline of Milestones and Corresponding Importance Factors at t=0, i.e., at t=5-15-2008—Tabular Format

Timeline of milestones and corresponding importance factors at t=0, i.e., at t=5-15-2008 in tabular format is shown in table below.

| | | Importance |
|---|---|---|
| | | Factor |
| Date | Milestone | (IF) |
| t = 0: May 15, 2008 | Milestone 0 or MS0 = Begin | |
| t = t1: Sep. 7, 2008 | MS1 = Meet with school counselor and decide which advanced | 2 |
| | placement (AP) courses should be taken. Goal is to get a score of 3 or | |
| | higher in all AP courses taken. | |
| t = t2: Nov. 15, 2008 | MS2 = Begin SAT test preparation. May want to enroll into a separate | 1 |
| | study program for SAT. | |
| t = t3: Mar. 10, 2009 | MS3 = Appear for SAT | 1 |
| t = t4: Sep. 1, 2009 | MS4 = Apply to colleges with goal to enroll into undergraduate | 1 |
| | degree suitable as pre-medical program | |
| t = t5: Nov. 1, 2009 | MS5 = Apply for scholarships to help support college tuition and | 1 |
| | board | |
| t = t6: Sep. 1, 2010 | MS6 = Join college for bachelor's degree | 2 |
| t = t7: Mar. 1, 2013 | MS7 = Begin MCAT test preparation. May want to enroll into a | 1 |
| | separate study program for MCAT. | |
| t = t8: Sep. 1, 2013 | MS8 = Appear for MCAT | 1 |
| t = t9: Jun. 1, 2014 | MS9 = Expected graduation with bachelor's degree. | 1 |
| t = t10: Sep. 1, 2014 | MS10 = Join college for master's degree at medical school | 3 |
| t = t11: Oct. 1, 2014 | MS11 = Begin USMLE tests preparation. May want to enroll into a | 3 |
| | separate study program for USMLE tests. | |
| t = t12: May 1, 2016 | MS12 = Take Step 1 of USMLE test | 4 |
| t = t13: Dec. 1, 2017 | MS13 = Take Step 2 of USMLE test | 4 |
| t = t14: Jun. 1, 2018 | MS14 = Expected graduation with master's degree. | 3 |
| t = t15: Sep. 1, 2018 | MS15 = Begin residency program | 4 |
| t = t16: Sep. 1, 2020 | MS16 = Take Step 3 of USMLE test | 4 |
| t = T: Jun. 1, 2022 | MS_{final} = goal = become a doctor | |
| (approximately) | | |

Note:
The above is a timeline (or, original timeline in contrast to conditional timeline) of milestones for a specific student profile. Several other timelines for other student profiles as well as conditional timelines are saved as part of main system database. Timeline can be more detailed or less detailed per expert advice for a given user profile.

Timeline of Milestones at t=0, i.e., at t=5-15-2008—Pictorial Format

Timeline of milestones at t=0, i.e., at t=5-15-2008 in pictorial format is shown in FIG. 7.

During Student's Progress Towards Goal

Scenario 1—The Student Stays on Track and Achieves Subgoals on Time

For example, say, on 3-4-2013, a user has begun MCAT test preparation and wants to know where he or she stands. System will provide following information:

User Standing, at the Moment

US(t)=100% because number of subgoals actually mastered are equal to number of subgoals to be mastered per schedule.

User Standing, Overall

$$US ( t / T ) = number of milestones achieved / total number of milestones to achieve final goal = 7 / 16 = 44 \%$$

User Achievement, at the Moment

UA(t)=100% because number of subgoals actually mastered are equal to number of subgoals to be mastered per schedule.

User Achievement, Overall

$$US ( t / T ) = sum of importance factors of milestones achieved / sum of importance factors of all milestones till final goal = ( 2 + 1 + 1 + 1 + 1 + 2 + 1 ) / ( 2 + 1 + 1 + 1 + 1 + 2 + 1 + 1 + 1 + 3 + 3 + 4 + 4 + 3 + 4 + 4 ) = 9 / 36 = 25 \%$$

Graphical Status Update

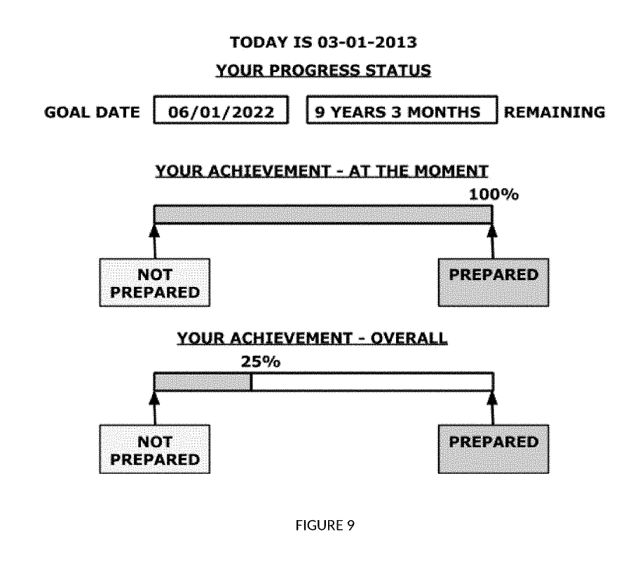

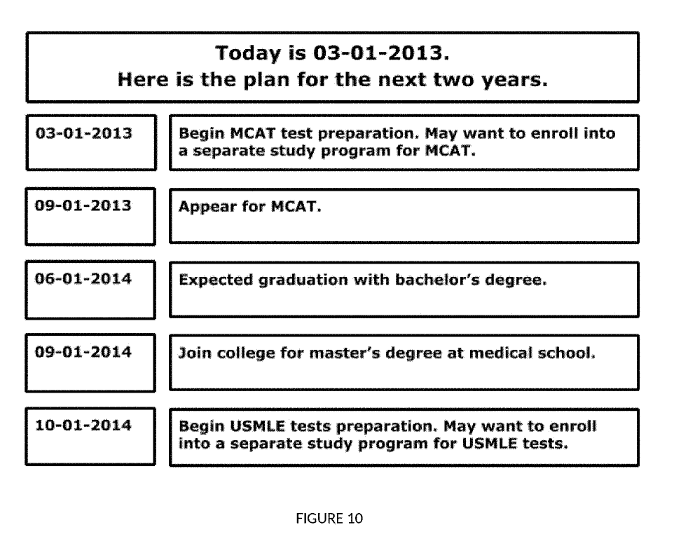

User is routinely informed of status and upcoming subgoals. This information is motivating to user. Progress status of user is shown in FIG. 8 and FIG. 9. Upcoming subgoals of user are shown in FIG. 10.

Scenario 2—The Student is Behind in Achieving Subgoals on Time

For example, say, on 6-15-2018, a user has begun USMLE test preparation but has not taken Step 1 of USMLE test. In other words, although per the original (t=0) schedule, at this time the user was supposed to have graduated with master's degree (i.e., milestone MS 14), but user has only achieved milestone MS 11 which, per original schedule, was supposed to be accomplished on 10-1-2014. Thus, by this measure, user is behind original schedule by approximately 3 years 9 months. However, per user feedback, graduation with master's degree (MS14) can be expected on 6-1-2019 which is only one year behind original schedule. User wants to know where he or she stands. System will provide the following information.

User Standing, at the Moment

$$US ( t ) = number of milestones achieved / number of milestones supposed to have been achieved = 11 / 14 = 79 \%$$

User Standing, Overall

US(t/T)=11/16=69%

User Achievement, at the Moment

UA(t)=(2+1+1+1+1+2+1+1+1+3+3)/(2+1+1+1+1+2+1+1+1+3+3+4+4+3)=17/28=61%

User Achievement, Overall

US(t/T)=17/36=47%

Graphical Status Update

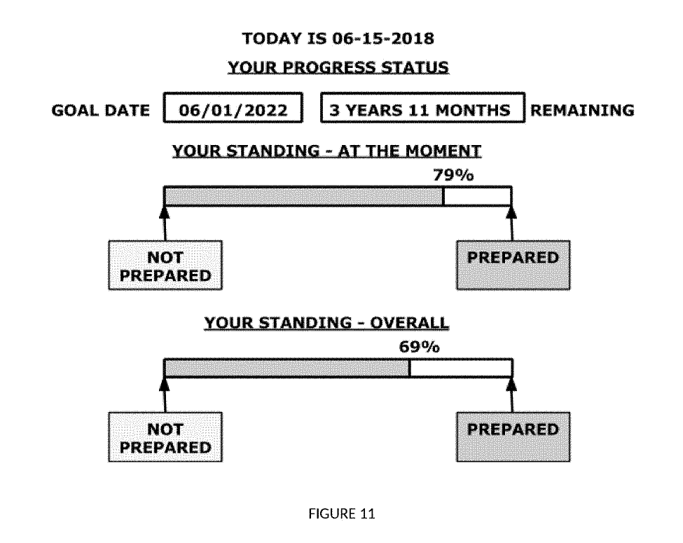

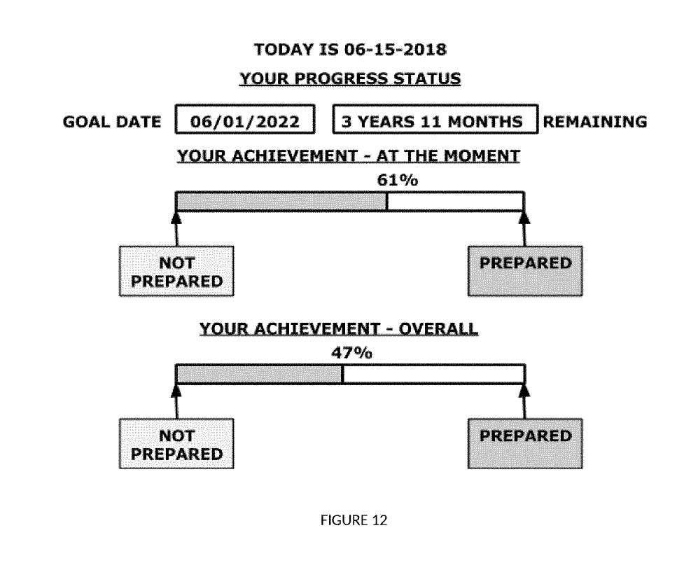

User is routinely informed of status and upcoming subgoals. This information is motivating to user. Progress status of user is shown in FIG. 11 and FIG. 12.

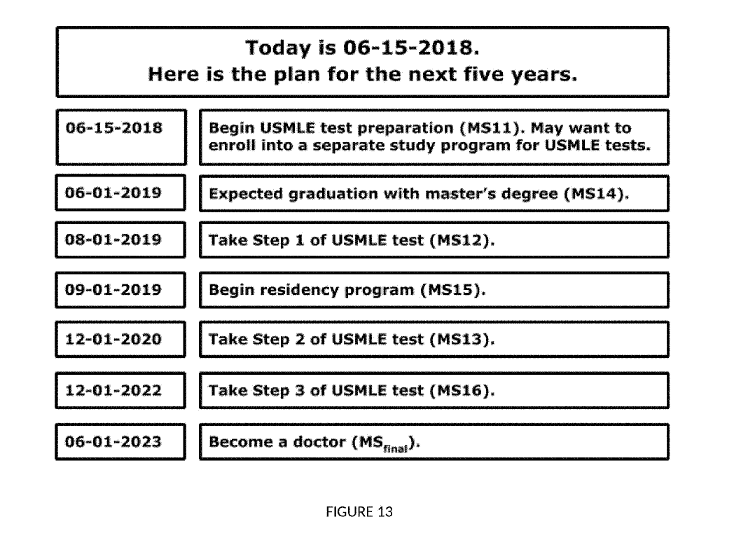

Further, based on user feedback, following revised plan is provided to the user which rearranges milestones or subgoals and delays reaching the final goal by approximately one year compared to the original (t=0) timeline. Thus rearranged, upcoming subgoals of user are shown in FIG. 13.

### DETAILED DESCRIPTION

### Second Embodiment

Goal—Test preparation: SAT

Setting Up of Modules

GUIDE 10

GUIDE 10 module consists of experts as following:
1. Two experts with SAT tutoring experience
2. One expert who is recent SAT taker high school student with scores in top 1 percentile
3. One expert who is recent SAT taker high school student with scores in top 20 percentile
4. Two experts who are recent SAT takers high school students with scores in lower 50 percentile but with very good school performance
5. One expert who has experience as test creator
6. One expert who is a family member of recent past test taker
7. One expert who is a family member of near future test taker
8. One lead expert to facilitate reaching to conclusions based on inputs from all experts.

Note that actual number and type of experts can vary so long as adequate number of people who have knowledge and/or actual experience with at least a part of the process and who are interested in and capable of sharing their knowledge and expertise.

GUIDE 10 module also consists of Guide System (possibly implemented via software) which collects and stimulates knowledge of experts by asking these questions:

Questions Whose Answer are Used to Help Set Up MAIN SYSTEM 2
1. How much time does SAT preparation typically take?
2. When is optimal time to begin SAT preparation?
3. What topics or skills are typically required to be mastered and how much time is necessary to prepare for each of them?
4. While all topics or skills would be important for SAT success, some would be more important that the others. Can you assign relative importance factors to various topics or skills?
5. What is the best sequence to study the topics or to master the skills considering their interdependencies?
6. During SAT preparation, if a specific topic or skill is not mastered in time, what actions should be taken?
7. If you're a family member of a recent past or near future test taker, what advice can you offer to a SAT test taker?

Questions Whose Answer are Used to Help Set Up USER EVALUATION AND SCREENING SYSTEM 8
8. What typical SAT taker profiles have you seen, and what are their characteristics? What questions would you ask to determine profile? How would a profile affect expected time to master a topic, and is there a preferred order of topics for a given profile?

Questions Whose Answer are Used to Help Set Up ALUMNUS GUIDE INTERFACE SYSTEM 12
9. What questions would you ask alumni of this system to gather their experience in order to update and improve this system for a SAT taker?

### SPECIFIC EXAMPLE

A student needs to take SAT. In the spring of 10th grade (i.e., high school sophomore year) the student opens the web site (or calls phone number) of this system. The student interacts with USER EVALUATION AND SCREENING SYSTEM 8l module which asks certain questions and gathers information. Next, USER EVALUATION AND SCREENING SYSTEM 8 interacts with MAIN SYSTEM 2 and, using collected information, determines profile of the user and expected timeline of milestones for that profile. Next, USER EVALUATION AND SCREENING SYSTEM 8 provides the student a time range when the student is recommended to take SAT. If student is not satisfied with this time range (or, not satisfied for any reason), student has choice to not enroll (and independently pursue achieving the goal in student's desired timeframe). If the student enrolls, the system creates an account and timeline at t=0 when student enrolled. Thus, if student enrolled on, say, Jan. 15, 2016, then t=0 represents Jan. 15, 2016.

Timeline of Milestones and Corresponding Importance Factors at t=0 i.e., at t=01-15-2016—Tabular Format

Timeline of milestones and corresponding importance factors at t=0, i.e., at t=01-15-2016 in tabular format are shown in table below,

| | | Importance |
|---|---|---|
| | | Factor |
| Date | Milestone | (IF) |
| t = 0: Jan. 15, 2016 | Milestone 0 or MS0 = Begin | |
| t = t1: Jan. 23, 2016 | MS1 = Overall understanding of SAT. Review and understand | 1 |
| | CollegeBoard Official SAT Study Guide Chapters 1 through 5. | |
| t = t2: Jan. 24, 2016 | MS2 = Mock test | 1 |
| t = t3: Feb. 24, 2016 | MS3 = Command of Evidence (evidence-based reading and | 4 |
| | writing) | |
| t = t4: Mar. 4, 2016 | MS4 = Heart of Algebra (Math) | 2 |
| t = t5: Mar. 15, 2016 | MS5 = Words in Context (evidence-based reading and writing) | 2 |
| t = t6: Mar. 30, 2016 | MS6 = Problem Solving and Data Analysis (Math) | 2 |
| t = t7: Apr. 15, 2016 | MS7 = Expression of Ideas (evidence-based reading and writing) | 2 |
| t = t8: Apr. 30, 2016 | MS8 = Passport to Advanced Math (Math) | 2 |
| t = t9: May 15, 2016 | MS9 = Standard English Conventions (evidence-based reading | 2 |
| | and writing) | |
| t = t10: May 17, 2016 | MS10 = Limited scope test (Math) | 1 |
| t = t11: Jun. 7, 2016 | MS11 = Essay (evidence-based reading and writing) | 3 |
| t = t12: Jun. 9, 2016 | MS12 = Limited scope test (evidence-based reading and writing) | 1 |
| t = t13: Jun. 12, 2016 | MS13 = Mock test | 2 |
| t = t14: Jul. 7, 2016 | MS14 = Review of selected material (Math) | 3 |
| t = t15: Aug. 18, 2016 | MS15 = Review of selected material (evidence-based reading | 3 |
| | and writing) | |
| t = t16: Aug. 21, 2016 | MS16 = Mock test | 2 |
| t = t17: Sep. 21, 2016 | MS17 = Review of selected material (evidence-based reading | 3 |
| | and writing, and Math) | |
| t = t18: Sep. 24, 2016 | MS18 = Limited scope test (Math) | 1 |
| t = t19: Sep. 28, 2016 | MS19 = Limited scope test (evidence based reading and writing) | 1 |
| t = T: Oct. 1, 2016 | MS_{final} = goal = Take SAT | |
| (approximately) | | |

Note:
The above is a timeline (or, original timeline, in contrast to conditional timeline) of milestones for a specific student profile. Several other timelines for other student profiles as well as conditional timelines are saved as part of main system database.

Timeline of Milestones at t=0, i.e., at t=01-15-2016—Pictorial Format

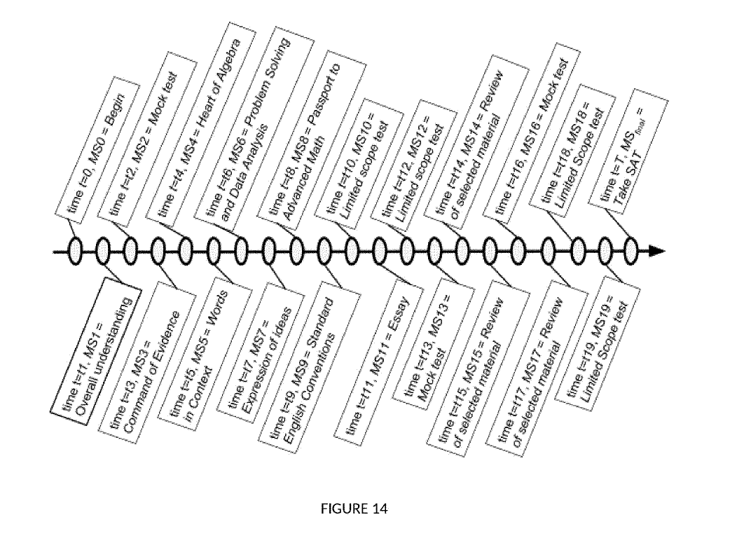

Timeline of milestones at t=0, i.e., at t=01-15-2016 in pictorial format are shown in FIG. 14.

During Student's Progress Towards Goal

Scenario 1—The Student Stays on Track and Achieves Subgoals on Time

For example, say, on 05-15-2016, a user has mastered milestone MS9 (Standard English Conventions) and wants to know where he or she stands. System will provide following information:

User Standing, at the Moment

US(t)=100% because number of subgoals actually mastered are equal to number of subgoals to be mastered per schedule.

User Standing, Overall

$$US ( t / T ) = number of milestones achieved / total number of milestones to achieve final goal = 9 / 19 = 47 \%$$

User Achievement, at the Moment

UA(t)=100% because number of subgoals actually mastered are equal to number of subgoals to be mastered per schedule.

User Achievement, Overall

US(t/T)=sum of importance factors of milestones achieved/sum of importance factors of all milestones till final goal=(1+1+4+2+2+2+2+2+2)/(1+1+4+2+2+2+2+2+2+1+3+1+2+3+3+2+3+1+1)=18/38=47%

Graphical Status Update

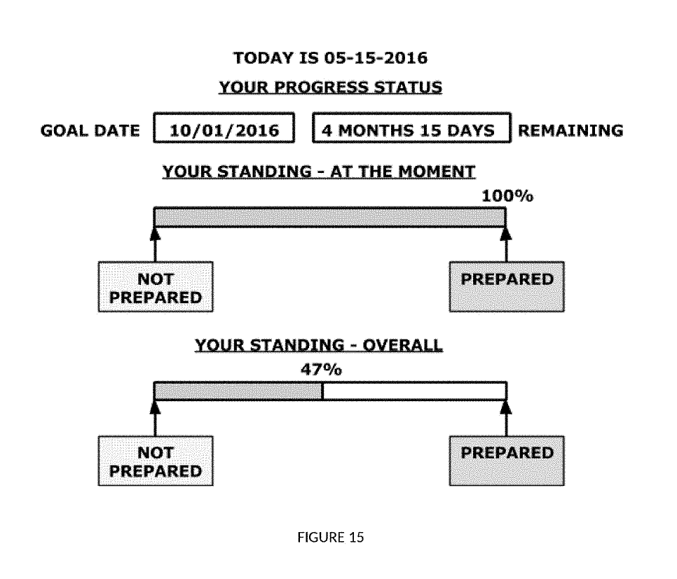

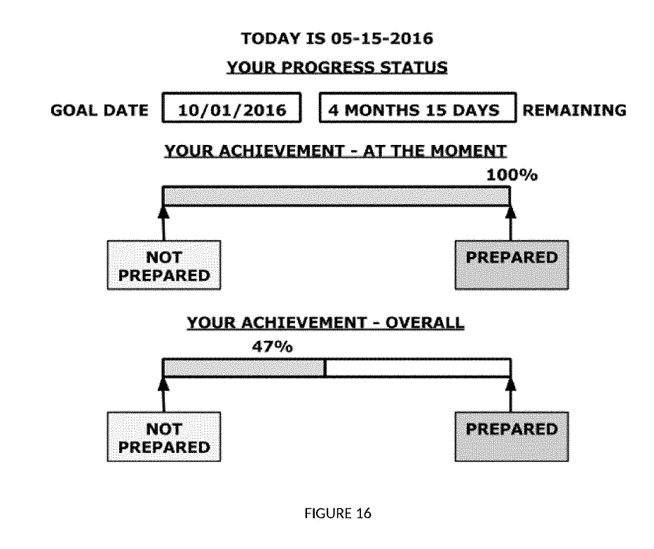

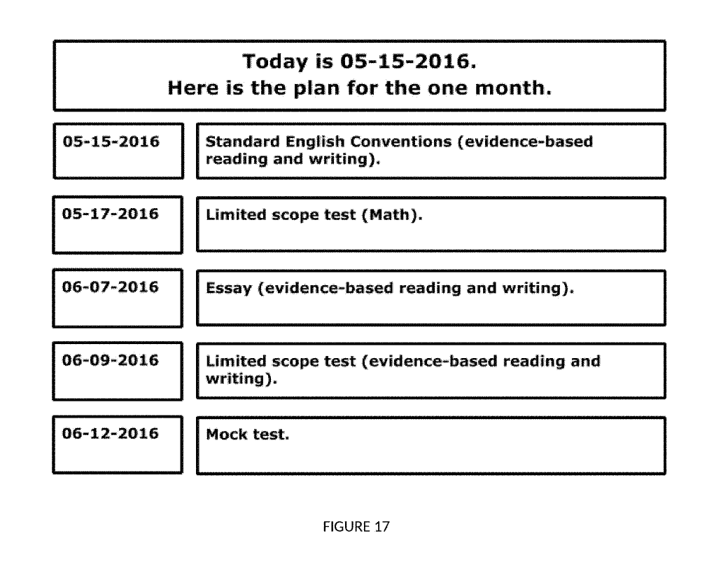

User is routinely informed of status and upcoming subgoals. This information is motivating to user. Progress status of user is shown in FIG. 15 and FIG. 16. Upcoming subgoals of user are shown in FIG. 17.

Scenario 2—The Student is Behind in Achieving Subgoals on Time

For example, say, on 8-18-2016, a user has completed Essay (MS11). Per the original (t=0) schedule, at this time the user was supposed to have completed Review of selected material (MS15), but user has only achieved milestone MS11, which, per original schedule, was supposed to be accomplished on 06-07-201.6. Thus by this measure, user, is behind original schedule by 2 months 11 days. User wants to know where he or she stands. System will provide the following information.

User Standing, at the Moment

$$US ( t ) = number of milestones achieved / number of milestones supposed to have been achieved = 11 / 15 = 73 \%$$

User Standing, Overall

US(t/T)=11/19=58%

User Achievement, at the Moment

UA(t)=(1+1+4+2+2+2+2+2+2+1+3)/(1+1+4+2+2+2+2+2+2+1+3+1+2+3+3)=22/31=71%

User Achievement, Overall

US(VT)=22/38=58%

Graphical Status Update

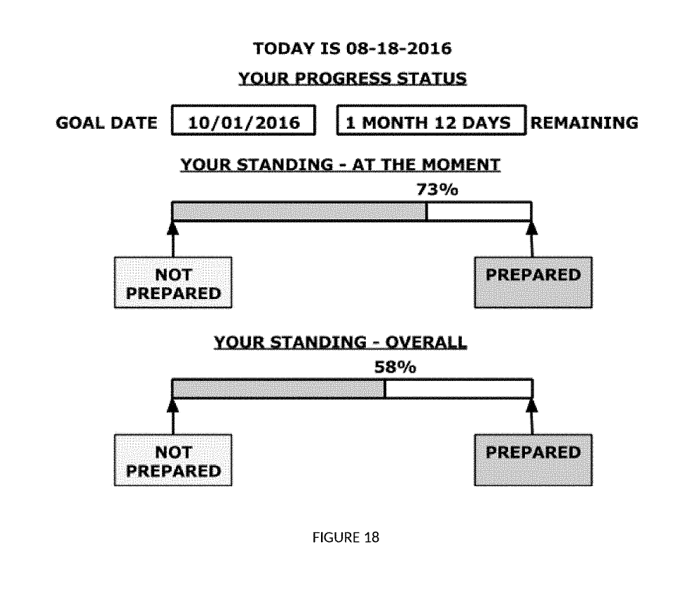

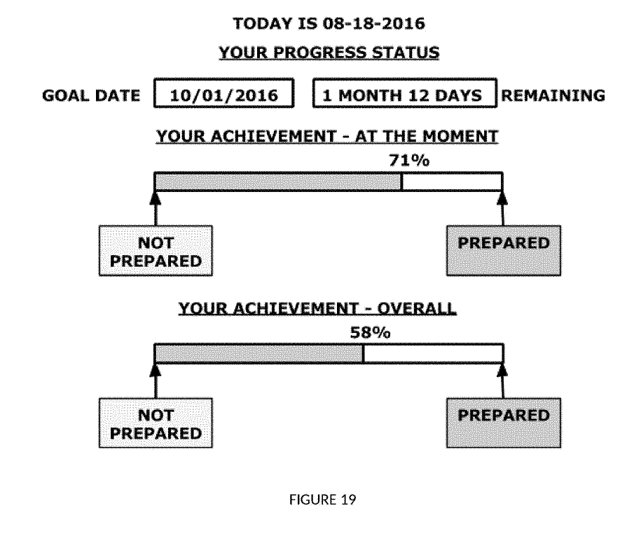

Progress status of user is shown in FIG. 18 and FIG. 19.

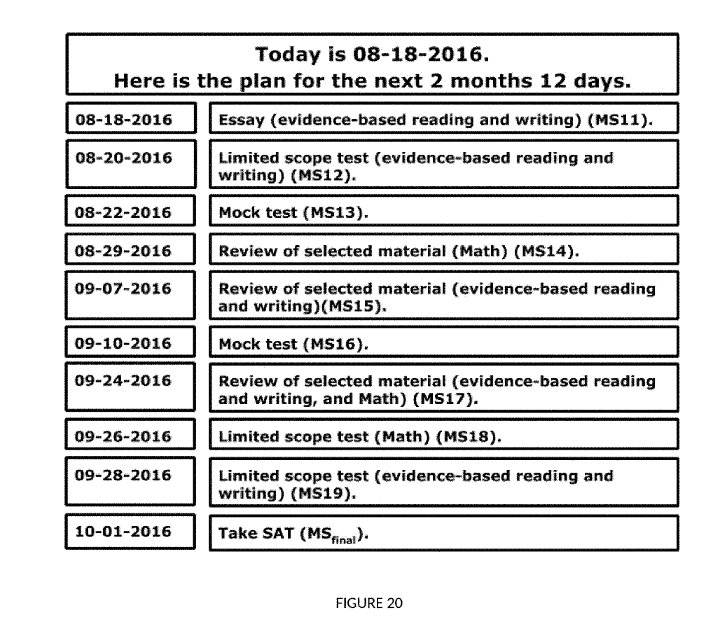

Further, based on user feedback, following revised plan is provided to the user which rearranges milestones or subgoals and helps user achieve the final goal at the same time as planned in the original (t=0) timeline. Thus rearranged, upcoming subgoals of user are shown in FIG. 20.

Conclusion, Ramifications, and Scope

Accordingly, the reader will see that the at least two embodiments of the system and method provide an effective, consistent, and foolproof technique for scheduling preparation and creating timeline for a user to achieve a specific goal in a timely manner.

While above embodiments contain many specificities, these should not be construed as limitations on the scope, but rather as an exemplification of two embodiments thereof. Many other variations are possible. For example, the system and method can be used:
with different types of interfaces.
with printed media (e.g., book) or in-person interaction.
with fewer or more modules compared to those described herein.
with or without continual interaction between modules.
with software/application installed on a computing device (e.g., desktop computer, laptop computer, smart phone, tablet, etc.).
with wearable devices.
with implantable devices.
with user interaction feature using social media or other process.
with live tutor feature with tutor interaction via internet and/or in person.
with adaptive software.
with software divided into components.
with positive and negative inducements and reinforcements.
with motivational techniques.
with immersive, technology-created experience where user is subjected to realistic life experience.

Accordingly, the scope should be determined not by the embodiments illustrated, but by the appended claims and their legal equivalents.

I claim:

1. A method to create a schedule consisting a timeline of milestones for goals of a user, comprising: a system, using at least one processing device or another machine, interacting with one or more experts to obtain expert-advice and develop schedule.

2. A method to determine user profile for said user of claim 1 at given time, comprising: a system, using at least one processing device or another machine, interacting with and observing said user and collecting information such as one or more of past achievements, style of learning, user subject-specific aptitude category, and, from information collected, determine expected achievement towards said goals in remaining time and assign user profile.

3. A method to measure achievement and standing of said user vis-a-vis said goals, comprising: a system, using at least one processing device or another machine, assigning importance factors to subgoals and comparing mastered subgoals to subgoals required to be complete in specific time interval with and without considering said importance factors, and calculating a score.

4. A method to arrange said subgoals of claim 2 in order, comprising: a system, using at least one processing device or another machine, assigning expected time required to achieve said subgoals, considering causalities and, dependencies between subgoals, considering said importance factors assigned to said subgoals, considering remaining time, considering said user profile, and maximizing said achievement in remaining time.

5. A method to direct user towards said goals, comprising: a system, using at least one processing device or another machine, interacting with said user to inform said user's standing and achievement of claim 2 and provide information on required subgoals to complete in specific time intervals.
